(19) United States
(12) Patent Application Publication
(10) Pub. No.: US 2006/0257455 A1
(43) Pub. Date: Nov. 16, 2006

(54) Hypoallergenic Flavor Compositions and Packages, and Methods of Managing Allergic Reactions in Pets

(76) Inventors: Qinyun Chen, O Fallon, MO (US); Thomas E. Webb JR., St Peters, MO (US)

Correspondence Address: CANTOR COLBURN, LLP, 55 GRIFFIN ROAD SOUTH, BLOOMFIELD, CT, 06002, US

(21) Appl. No.: 11/383,334

(22) Filed: May 15, 2006

Related U.S. Application Data
(60) Provisional application No. 60/681,291, filed on May 16, 2005.

(51) Int. Cl. A23K 1/165; A23K 1/17

(52) U.S. Cl. 424/442; 426/635

(57) ABSTRACT

Hypoallergenic flavor compositions for human and animal foods are described. A method of managing allergic reactions in an animal comprises providing to the animal a hypoallergenic animal food composition comprising a hypoallergenic flavor composition, wherein the hypoallergenic flavor composition comprises substantially all components having a weight average molecular weight of less than 4,000 daltons. The hypoallergenic flavor composition may comprise an oil or fat-based reaction flavor, a water-based reaction flavor, a hypoallergenic animal digest, or a combination comprising one or more of the foregoing components. Also described are packages comprising hypoallergenic animal foods.

### CROSS REFERENCE TO RELATED APPLICATIONS

This application claims priority from Provisional Application Ser. No. 60/681,291, filed October May 16, 2005, which is incorporated herein by reference in its entirety.

### BACKGROUND

Food allergies are common in people. Typically, people deal with food allergies by avoiding the particular foods that cause allergic reactions. In the case of infants, there are hypoallergenic formulas containing protein hydrolysates that do not stimulate allergic reactions and also provide complete nutrition.

Food allergies, or food hypersensitivities, commonly afflict household pets such as dogs and cats. Such food allergies, which are also known as food hypersensitivities, often manifest themselves by itching, swelling, vomiting, diarrhea (and sometimes even bronchoconstriction and anaphylaxis), and can be difficult to diagnose. It has been estimated that at least 15% of all dogs in the United States suffer from allergies of some type, and that 10% of those arise from food hypersensitivities. Intact proteins in foods are intrinsically antigenic and can be the source of pet allergies. Hydrolysis of proteins has been employed to mitigate antigenicity in human and pet nutrition, particularly in basal animal food compositions.

There are three categories of pet food: (1) canned or high moisture content products (e.g., greater than about 50% moisture), which are typically all-meat products and which are generally more palatable to the animal; (2) dry or low moisture content products (typically, less than about 15% moisture), which have the highest nutritional content, least expensive packaging, greatest convenience, but are least palatable; and (3) semi-dry or intermediate moisture content products (typically 15% to 50% moisture), which generally have a nutritional value higher than canned food and are easier to package and more convenient to use, but may also be less palatable than canned food, but more palatable than dry food. Animal foods such as pet foods typically contain flavor compositions to increase the palatability of the food to the animal. Flavor compositions for pet food often include a meat digest such as an enzymatic digest of chicken livers which makes the food more palatable to the target animal. Such animal digests contain proteins than can cause allergies in pets. There thus is a need for hypoallergenic flavor compositions for animal foods.

### SUMMARY

A method of managing allergic reactions in an animal comprises providing to the animal a hypoallergenic animal food composition comprising a hypoallergenic flavor composition, wherein the hypoallergenic flavor composition comprises a water-based reaction flavor, wherein the water-based reaction flavor is produced by reacting water, a reducing sugar, a sulfur source, and a furanone.

A hypoallergenic flavor composition suitable for human or animal comprises an oil or fat-based reaction flavor and a water-based reaction flavor, wherein the oil or fat-based reaction flavor is produced by reacting a first precursor composition comprising a vegetable oil, an animal fat, or a combination comprising one or more of the foregoing fats and oils; a reducing sugar; and a sulfur source; and wherein the water-based reaction flavor is produced by reacting a second precursor composition comprising water, a reducing sugar, a sulfur source, and a furanone.

A flavor composition for an animal food comprises a hypoallergenic animal digest, wherein substantially all of the components of the hypoallergenic animal digest have a molecular weight of less than 4,000 daltons; and an oil or fat-based reaction flavor, a water-based reaction flavor, or a combination comprising one or more of the foregoing reaction flavors.

### DETAILED DESCRIPTION OF THE INVENTION

“Allergy” as used herein refers to altered bodily reactivity to a substance in response to an earlier exposure. An “allergic reaction” is a negative reaction to a substance such as a food composition. “Allergen” as used herein is a substance that induces an allergy. “Antigen” as used herein refers to a substance capable of eliciting an immune response in a mammal. The term mammal includes humans and animals including household pets. “Food hypersensitivity” refers to an allergy or other immune-mediated adverse reaction to a food fed to a mammal. “Hypoallergenic” refers to a composition that, when fed to a mammal at customary levels that provide adequate nutrition over the mammal's life, does not produce a clinically discernible allergic reaction. “Dalton” (Da) as used herein conforms to common scientific usage to refer to a single gram atomic weight; thus a kiloDalton, abbreviated kDa, is a kilogram atomic weight. “Weight average molecular weight” as used herein conforms to common scientific usage in referring to an average molecular weight calculated as the mass-weighted average of the molecular weights of the components of a mixture.

Allergies typically result from adverse reactions to proteins that the immune system recognizes as foreign. As used herein, a hypoallergenic protein is a protein having a weight average molecular weight of less than or equal to about 4,000 Da. While hypoallergenic foods are commercially available for human and animal consumption, commercially available animal foods typically either contain no added flavor composition or a small amount of a non-hypoallergenic flavor composition. To increase the palatability of hypoallergenic foods for animals, it is thus desirable to employ hypoallergenic flavor compositions.

A hypoallergenic flavor composition is one in which substantially all of the components of the flavor composition have molecular weights of less than about 4,000 Da. By substantially all, it is meant that greater than 98 wt %, more specifically greater than 99.5 wt % of the flavor components in the flavor composition have molecular weights below 4,000 Da. In one embodiment, the flavor composition is suitable for an animal and the flavor composition is palatable to the animal for which it is intended. Palatability refers to the overall willingness of the animal to eat a certain food. In another embodiment, the flavor composition is suitable for human consumption.

One complication in developing flavorants and palatability enhancers for animals such as pets is unpredictability. Flavorants which work effectively with humans do not often work as effectively with animals. Similarly, a flavorant which is effective with one species may not work as well with a different animal group. Furthermore, animals are unable to express their preferences in an effective manner. Thus, without animal testing, it is difficult to predict which flavors and palatants will be effective for animals.

In one embodiment, a hypoallergenic flavor composition comprises an oil or fat-based reaction flavor formed by reacting a first precursor composition comprising a vegetable oil, an animal fat, or a combination comprising one or more of the foregoing fats and oils; a reducing sugar, and a sulfur source. By reacting, it is meant that the components are heated for a time and a temperature sufficient for at least a portion of the first precursors to react. The first precursor composition may optionally further comprise a nitrogen source, a spice, an animal digest, a furanone, an antioxidant, or a combination comprising one or more of the foregoing components. The animal digest may comprise proteins having molecular weights of less than 4,000 Da.

Suitable oils include vegetable oils such as, for example, corn oil, olive oil, safflower oil, peanut oil, palm oil, rapeseed oil, soybean oil, cottonseed oil, coconut oil, canola oil, and combinations comprising one or more of the foregoing oils. Suitable fats include, for example, beef fat (which includes beef tallow), pork fat (which includes pork lard), poultry fat (which can include chicken and/or turkey fat), fish oils, and combinations comprising one or more of the foregoing fats. Combinations of oils and fats may also be employed. Suitable sulfur sources include, for example, ammonium sulfide, sodium sulfide, sodium sulflhydrate, potassium sulfide, hydrogen sulfide, cysteine, methionine, thiamine, and combinations comprising one or more of the foregoing sulfur-sources. Suitable reducing sugars include, for example, xylose, hexose, pentose, dextrose, fructose, and combinations comprising one or more of the foregoing reducing sugars. Suitable nitrogen sources include, for example, ammonium sulfide, ammonium sulfate, ammonium hydrogen sulfate, diammonium carbonate, ammonium bicarbonate, ammonium chloride, ammonium nitrate, ammonium hydroxide, di-ammonium phosphate, amino acids such as glutamic acid, glycine, and combinations comprising one or more of the foregoing nitrogen sources. In some embodiments, components such as cysteine and methionine can serve as both a sulfur source and a nitrogen source. Suitable spices include, for example, garlic, onion, and combinations comprising one or more of the foregoing spices. Suitable furanones include, for example, 4-hydroxy-2,5-dimethyl-3(2H)-furanone, 4-hydroxy-5-methyl-3(2H)-furanone, and combinations comprising one or more of the foregoing furanones. 4-Hydroxy-2,5-dimethyl-3(2H)-furanone is commercially available as Furanone® from Firmenich SA, Geneva, Switzerland. Suitable antioxidants include, for example, ascorbic acid.

In one embodiment, the first precursor composition comprises about 30 wt % to about 95 wt % of the vegetable oil or animal fat, about 3 wt % to about 20 wt % of the sulfur source, about 3 wt % to about 20 wt % of the reducing sugar, about 5 wt % to about 30 wt % of the nitrogen source, about 0 wt % to about 20 wt % of the animal digest, about 0.01 wt % to about 3 wt % of the spice, about 0.1 wt % to about 5 wt % of the furanone, and about 0.01 wt % to about 0.05 wt % of the antioxidant. The balance of the first precursor composition may be water. Specifically, the first precursor composition comprises about 35 wt % to about 75 wt % of the vegetable oil or animal fat, about 5 wt % to about 18 wt % of the sulfur source, about 5 wt % to about 15 wt % of the reducing sugar, about 8 wt % to about 25 wt % of the nitrogen source, about 5 wt % to about 15 wt % of the animal digest, about 0.02 wt % to about 1 wt % of the spice, about 0.1 wt % to about 3 wt % of the furanone, and about 0.01 wt % to about 0.04 wt % of the antioxidant. More specifically, the first precursor composition comprises about 40 wt % to about 60 wt % of the vegetable oil or animal fat, about 8 wt % to about 12 wt % of the sulfur source, about 8 wt % to about 10 wt % of the reducing sugar, about 12 wt % to about 18 wt % of the nitrogen source, about 8 wt % to about 12 wt % of the animal digest, about 0.03 wt % to about 0.06 wt % of the spice, about 0.15 wt % to about 0.5 wt % of the furanone, and about 0.015 wt % to about 0.03 wt % of the antioxidant. All weight percents (wt %) are based on the total weight of the first precursor composition.

The oil or fat-based reaction flavor composition can be formed by combining the ingredients of the first precursor composition and optionally adjusting the pH to 4.0 to 8.0 with sodium hydroxide, phosphoric acid, another acid or base, or a combination comprising one or more acids and/or bases. Heating of the first precursor composition is performed at a temperature and for a time sufficient to produce reaction between the components of the first precursor composition. Heating may be performed at a temperature of about 70° C. to about 120° C. (e.g., 110° C.) for about 20 to about 180 minutes (e.g., 120 minutes) to form the oil or fat-based reaction flavor. The oil or fat-based reaction flavor is then cooled to room temperature. Optionally, stabilizers such as potassium sorbate and antioxidants (e.g., pfaloux, BHA, or natural antioxidants such as rosemary oil) may be added. The antioxidant may be present in an amount of up to about 5 wt %, specifically up to about 3 wt %, based on the total weight of the flavor composition. The pH of the reaction flavor may then be adjusted to about 4 to about 6 (e.g., 5.5) by the addition of sodium hydroxide.

In another embodiment, a hypoallergenic flavor composition comprises a water-based reaction flavor formed by reacting a second precursor composition comprising water, a reducing sugar, a sulfur source, and a furanone. The second precursor composition optionally further comprise a nitrogen source, a spice, an animal digest, an antioxidant, or a combination comprising one or more of the foregoing components. Suitable components for the second precursor composition are those described above for the first precursor composition.

In one embodiment, the second precursor composition comprises about 5 wt % to about 20 wt % of the sulfur source, about 3 wt % to about 15 wt % of the reducing sugar, about 0.3 wt % to about 2 wt % of the furanone, about 0 wt % to about 10 wt % of the animal digest, about 0.1 wt % to about 1 wt % of the spice, about 5 wt % to about 20 wt % of the nitrogen source, and about 0.01 wt % to about 0.05 wt % of the antioxidant. The balance of the second precursor composition may be water. Specifically, the second precursor composition comprises about 8 wt % to about 15 wt % of the sulfur source, about 5 wt % to about 10 wt % of the reducing sugar, about 0.4 wt % to about 1 wt % of the furanone, about 3 wt % to about 8 wt % of the animal digest, about 0.2 wt % to about 0.8 wt % of the spice, about 8 wt % to about 15 wt % of the nitrogen source, and about 0.015 wt % to about 0.03 wt % of the antioxidant. More specifically, the second precursor composition comprises about 10 wt % to about 13 wt % of the sulfur source, about 5 wt % to about 8 wt % of the reducing sugar, about 0.5 wt % to about 0.8 wt % of the furanone, about 5 wt % to about 8 wt % of the animal digest, about 0.4 wt % to about 0.6 wt % of the spice, about 10 wt % to about 13 wt % of the nitrogen source, and about 0.015 wt % to about 0.03 wt % of the antioxidant. All weight percents are based on the total weight of the second precursor composition.

The water-based flavor composition can be formed by combining the ingredients of the second precursor composition and optionally adjusting the pH to 4.0 to 8.0, with sodium hydroxide, phosphoric acid, another acid or base, or a combination comprising one or more acids and/or bases. Heating of the second precursor composition is performed at a temperature and for a time sufficient to produce reaction between the components of the second precursor composition. Heating may be performed at a temperature of about 70° C. to about 140° C. (e.g., 120° C.) for about 20 to about 120 minutes (e.g., 60 minutes) to form the reaction flavor. The reaction flavor is then cooled to room temperature. Optionally, stabilizers such as potassium sorbate and antioxidants may be added.

The reaction flavors may be used as a liquid flavor in either unconcentrated or concentrated form. If the flavor composition is to be a dry flavor composition, the flavor composition may be dried in a suitable dryer such as, for example, a spray dryer, or an oven dryer. The final filler composition may comprise a filler such as, for example, maltodextran, gum, or a combination comprising one or more of the foregoing fillers.

In another embodiment, a hypoallergenic flavor composition comprises a combination of an oil or fat-based reaction flavor and a water-based reaction flavor as described above. The combination flavor composition may be suitable for human and/or animal consumption. In addition to the reaction flavors, the combination flavor may also comprise a filler such as, for example, maltodextran, gum, or a combination comprising one or more of the foregoing fillers. In one embodiment, the combination flavor comprises about 5 wt % to about 15 wt % of the fat or oil-based reaction flavor, about 5 wt % to about 15 wt % of the water-based reaction flavor, and about 15 wt % to about 35 wt % of the filler, based on the total weight of the combination flavor composition. The balance of the flavor composition may comprise water. Specifically, the combination flavor comprises about 5 wt % to about 10 wt % of the fat or oil-based reaction flavor, about 5 wt % to about 10 wt % of the water-based reaction flavor, and about 20 wt % to about 35 wt % of the filler, based on the total weight of the combination flavor composition. More specifically, the combination flavor comprises about 8 wt % to about 10 wt % of the fat or oil-based reaction flavor, about 8 wt % to about 10 wt % of the water-based reaction flavor, and about 28 wt % to about 32 wt % of the filler, based on the total weight of the combination flavor composition.

In yet another embodiment, a hypoallergenic flavor composition comprises a hypoallergenic animal digest; and a fat or oil-based reaction flavor, a water-based reaction flavor, or a combination comprising one or more of the foregoing reaction flavors.

An animal digest, also called a meat digest, comprises meat or animal by-products that are hydrolyzed using heat, enzymes, or both. A hypoallergenic animal digest is one in which all of the components of the digest have a molecular weight of less than 4,000 Da. The proteolytic enzymes that may be employed include, but are not limited to, papain, bromelain and ficin, and combinations comprising one or more of the foregoing enzymes. The enzymes are employed in amounts sufficient to yield a pureed meat texture after digestion is completed.

In this embodiment, the flavor composition comprises about 5 to about 30 wt % of a hypoallergenic animal digest, specifically about 8 wt % to about 25 wt %, and more specifically about 10 wt % to about 20 wt %, based on the total weight of the flavor composition. The flavor composition also comprises about 5 to about 25 wt % of a reaction flavor, specifically about 8 wt % to about 20 wt %, and more specifically about 12 wt % to about 18 wt %, based on the total weight of the flavor composition. The reaction flavor may comprise an oil or fat-based reaction flavor, a water-based reaction flavor, or a combination comprising one or more of the foregoing reaction flavors.

The flavor compositions as described above are combined with hypoallergenic food composition such as a basal animal food composition. “Basal animal food composition” and “basal composition”, as used herein, refer to an animal food combinable with the flavor composition. In one embodiment, the animal food is formulated for dogs, and includes dry dog food, canned dog food, semi-dry dog food, edible dog treats, and the like, and combinations comprising one or more of the foregoing dog foods. In addition to basal dog food compositions, the disclosed flavor composition may also be used in other pet food compositions such as those for other companion animals such as cats, pot-bellied pigs, and ferrets, as well as pocket animals including mice, hamsters and guinea pigs. As used herein, a basal food composition may be uncoated, or may be coated, for example, with a fat coating.

In one embodiment, the basal animal food composition is a dry pet food and/or a semi-dry pet food, formulated for dogs, for example. The basal composition may comprise poultry, pork, lamb or beef by-products; vegetable protein meals; animal proteins; animal tissue or meals; grains (e.g., corn, milo, alfalfa, wheat, soy, and the like); carbohydrates; fat (e.g., tallow); minerals; vitamins; preservatives; and combinations comprising one or more of the foregoing ingredients. “By-product” refers to the non-rendered part of a carcass of a slaughtered animal, including a mammal, bird, or fish. In one embodiment, the basal composition is one that is commercially sold, and is nutritionally balanced, preferably for dogs or cats. A dry basal composition may be in bite size or pellet form of a suitable shape, such as a kibble.

The flavor composition may be combined with the basal animal food composition in an amount effective to impart increased palatability of the food to the target animal. Effective amounts are readily determined by one of ordinary skill in the art without undue experimentation, particularly in view of the general guidance provided below.

The flavor composition may be combined with the basal animal food composition in a manner such that the flavor composition is incorporated into the basal animal food composition. By incorporated it is meant that the flavor composition is intimately associated with the basal animal food composition and does not become dissociated, for example, during normal storage conditions. In one embodiment, the flavor composition is substantially uniformly dispersed throughout the basal food composition. The flavor composition may be deposited in the basal food composition in an amount effective to provide about 0.5 wt % to about to about 3 wt %, specifically about 0.8 wt % to about 2.5 wt %, and more specifically about 1 wt % to about 2 wt % of the dry weight of the basal food composition.

In another embodiment, the flavor composition is deposited on the surface of the basal composition, for example in the form of a coating. Coating the basal food composition includes the topical deposition of the flavor composition onto the surface of the basal composition, such as by spraying, dusting, and the like. The coating comprising the flavor composition may comprise a fat or another adhesive to facilitate adhesion of the flavor composition to the surface of the basal food composition. It is possible, although not required, that the flavor composition be coated onto the basal composition uniformly or that uniform distribution of the flavor composition be achieved, for example, by repeatedly tumbling the coated food. One or more coats may be applied. The flavor composition may be deposited onto the surface of the basal food composition in an amount effective to provide about 0.5 wt % to about to about 3 wt %, specifically about 0.8 wt % to about 2.5 wt %, and more specifically about 1 wt % to about 2 wt % of the dry weight of the basal food composition.

The flavor composition may be both dispersed in and coated onto the basal food composition.

The basal food composition and/or the flavor composition may further comprise an additional palatability enhancer such as a flavoring. Suitable flavorings include, for example, a vegetable flavoring, a meat flavoring, (e.g., liver flavoring), a cheese flavoring, yeast, sodium pyrophosphate, a fat, an acid phosphate, a phosphate salt, and/or other food or flavor ingredients utilized by the animal feed and flavor industry in order to improve palatability. Suitable meat flavorings include, for example, meat-derived flavorings (e.g., beef, pork, bacon, lamb, ham, fish, chicken, turkey, and/or other poultry flavoring).

In one exemplary method of manufacture, a basal animal food composition comprises a fat coating. The term “fat” refers to an edible grade fat or lipid, including fats of avian (e.g., fats derived from the tissue of chickens, turkeys, ducks, and geese), animal (e.g., animal tallow, choice white grease, lard, milk-derived fats such as butter oil, and fat typically contained in cheese), plant (e.g., coconut oil, soybean oil, and corn oil), or fats of a manufactured origin, including, but not limited to, crude or refined fats. To form a fat coating, kibbles (i.e., pellets), of the uncoated basal food composition may be placed in a convenient container for mixing, for example, a small cement mixer, tub, or coating drum. A fat, such as lard, critical animal fat, or beef tallow, may be heated to about 160° F. and sprayed onto the basal composition to provide a coating on the kibbles. The coating need not be a continuous layer, but a substantially uniform coverage of the kibble is preferred. The basal composition may be mixed during coating and for a few minutes after coating the fat to improve the uniformity of the coating. After the fat is applied, it cools quickly and may act as an imperfect barrier to other compounds (i.e., coatings) that are applied following the fat coating. At this point, a hypoallergenic flavor composition may be applied as either a dry powder or a liquid. A flavor composition may, for example, be applied by spraying, while a dry product may be applied by mixing. A dry flavor composition may be dusted on, optionally through a mesh screen during mixing, to make the application more uniform on the kibbles.

In an alternative method of manufacture, at least a portion of the flavor composition can be coated onto the basal composition before deposition of a fat coating and/or as part of a fat coating. For example, the flavor composition may be dispersed in a fat and coated onto the basal composition with the fat. The flavor composition may be coated onto the basal composition uniformly. Uniform distribution of the flavor composition may be achieved, for example, by repeatedly tumbling the coated pet food during and/or after coating. One or more coats may be applied. A particular sequence of coats is not critical.

The above-described flavor compositions provide significant advantages over the prior art. As shown below, effective amounts of the flavor compositions can provide consumption ratios of 2.1 when compared to no flavor and tested on dogs. As is known in the industry, food comparisons involving animals tend to have a high degree of variability. Thus, small improvements in the consumption ratio may be significant.

In one embodiment, an article of manufacture comprises a sealed package, the sealed package comprising therein a hypoallergenic animal food composition comprising a hypoallergenic flavor composition, wherein the hypoallergenic flavor composition comprises substantially all components having a weight average molecular weight of less than 4,000 daltons; and a label affixed to the package, the label stating that the food product contains a hypoallergenic flavor composition. The package may be, for example, a bag, a box, or a can.

A method of managing allergic reactions in an animal comprises providing to the animal a hypoallergenic animal food composition comprising a hypoallergenic flavor composition, wherein the hypoallergenic flavor composition comprises substantially all components having a weight average molecular weight of less than 4,000 daltons. The animal may be, for example, a dog or a cat. Managing includes reducing the incidence of allergic reactions in the animal.

The invention will be further described by reference to the following examples, which are presented for the purpose of illustration only and are not intended to limit the scope of the invention. Unless otherwise indicated, all amounts are listed as parts by weight.

### EXAMPLES

The test data tabulated in the examples is derived from the industry standard two bowl comparison. In this test, each animal is presented with two bowls of food, each containing a measured amount of either the control ration or the test ration. The control and test rations contain the same or similar basal compositions. The animal is allowed to select the food it prefers. The amount of food eaten from each bowl is measured. A direct comparison of the amount eaten from the two rations gives a reliable indication of relative palatability.

For example, a dog may be given two bowls with equal amounts of food, one containing no additive and one containing the flavor composition to be tested. The amount of food in the two bowls is weighed prior to giving them to the dog. During the test, steps should be taken to ensure that the dog does not finish one bowl and continue to the other because it is still hungry. This can be accomplished, for example, by limiting the time of the dog with the two bowls, or by providing enough food in each bowl to fully satisfy the dog.

At the end of the test, the two bowls are weighed again to determine the amount of food eaten from each bowl. The larger quantity is divided by the smaller quantity to provide a quantity greater than 1. If more food is eaten from the bowl with the test flavor composition, the ratio is recorded as a positive value to indicate that the flavor composition had a positive effect. If more food was eaten from the bowl with the control food, the ratio is recorded as a negative value to indicate that the flavor composition did not perform as well as the control food.

For the tests, the flavor compositions were applied to a dry hypoallergenic basal cat food composition. Twenty dogs were fed for two days to give a total of forty choices. The bowl position was changed daily to eliminate dogs that show a preference for right or left placement of the bowls. The cumulative amounts of the amounts of the two rations eaten were used to calculate the consumption ratio (C.R.). The ration with more eaten was divided by the ration with less eaten to give a ratio greater than 1. For example, a C.R. of 2 means that twice as much of one ration was eaten compared to the other ration.

In the following examples, two dry test flavors for dogs were employed. Test flavor 1 (140) contained 8.7 wt % of an oil-based reaction flavor, 8.7 wt % of a water-based reaction flavor, 50.2 wt % water, 29.5 wt % Maltrin M100 maltodextran and 2.9 wt % purity gum 200. Test flavor 2 (137) contained 9.1 wt % of an oil-based reaction flavor, 4.5 wt % of a water-based reaction flavor, 52.5 wt % water, 30.9 wt % Maltrin M100 maltodextran and 3.0 wt % purity gum 200.

In both test flavors, the oil-based reaction flavor was formed by heating 1487.03 g coconut oil (52.7 wt %) and 552.94 g (19.58 wt %) water to 140° F. To this mixture was added 213.82 g dextrose (7.57 wt %), 41.5 g xylose (1.47 wt %), 56.6 g methionine (2 wt %), 264.13 g cysteine (9.35 wt %), 94.33 g glutamic acid (3.34 wt %), 41.5 g ascorbic acid (1.47 wt %), 6.29 g Furaneol® (0.22 wt %), and 1.26 g garlic oil (0.04 wt %). The pH was adjusted to 5.5 by adding 64.14 g sodium hydroxide (2.27 wt %), and the mixture was heated at about 110° C. for about 120 minutes. After heating, the mixture was cooled and 0.56 g of Pfaloux P3 PM (0.02 wt %) was added.

In both test flavors, the water-based reaction flavor was formed by heating 2717.40 g (77.64 wt %) water to 140° F. To this mixture was added 119 g dextrose (3.4 wt %), 119 g xylose (3.4 wt %), 119 g methionine (3.4 wt %), 70 g cysteine (2 wt %), 24.5 g glycine (0.7 wt %), 61.25 g ascorbic acid (1.75 wt %), 245 g thiamine (7 wt %), and 23.98 g Furaneol® (0.69 wt %). The mixture was heated at about 110° C. for about 60 minutes. After heating, the mixture was cooled and 0.7 g of Pfaloux P3 PM (0.02 wt %) was added.

The results are shown in the Table. Both flavors were coated onto a hypoallergenic dry dog kibble at a concentration of 1 wt % of the total weight of the kibbles.

TABLE

| | | Consumption ratio |
|---|---|---|
| Test Flavor | Control Flavor | (test/control) |
| Test flavor 1 | No flavor | 2.2 |
| Test flavor 2 | No flavor | 2.7 |

As shown in the Table, the dogs tested had a clear preference for a dry dog food coated with a flavor composition coated with a hypoallergenic flavor composition compared to no flavor composition. Hypoallergenic flavor compositions can increase the palatability of hypoallergenic animal food compositions for the animal for which they are intended.

Hypoallergenic flavors suitable for use in human foods and animal foods such as pet foods have been described. Suitable hypoallergenic flavors include oil or fat-based reaction flavors, water-based reaction flavors and combinations comprising one or more of the foregoing flavors. The flavor compositions are particularly useful for animal foods such as dog and cat foods. Human flavors are typically simple volatile or non-volatile organic chemicals which impart desirable odor and taste to foodstuff. Acceptance of a human flavor can be readily established by an individual or by a panel of expert tasters. Pet food flavors and palatability enhancers, in contrast, have aroma, taste and mouthfeel that are acceptable to the dogs and cats. This acceptance should be determined for a panel of animals by the keen observations of a scientist trained in that skill. A flavor composition for an animal food should improve acceptance and/or consumption by the animal in a statistically significant manner. Flavor compositions for pet foods should also be of nutritional value because animals have the natural ability to reject food which may be harmful to their well-being by the smell of the food. Because of the sensitivity of animals to negative palatants, flavor compositions for pet foods should be substantially free from negative palatants. Also, advantageously, flavor compositions for animal foods, particularly dry foods, should be stable under low water activity since they may be utilized in a low pH (e.g., pH 3.0 or lower), stored and applied at relatively high temperature (e.g., 120° F.).

While the invention has been described in terms of various specific embodiments, those skilled in the art will recognize that the invention can be practiced with modification within the spirit and scope of the claims.

1. A method of managing allergic reactions in an animal, comprising providing to the animal a hypoallergenic animal food composition comprising a hypoallergenic flavor composition, wherein the hypoallergenic flavor composition comprises a water-based reaction flavor, wherein the water-based reaction flavor is produced by reacting water, a reducing sugar, a sulfur source, and a furanone.

2. The method of claim 1, wherein the animal is a pet.

3. The method of claim 2, wherein the pet is a dog or a cat.

4. The method of claim 1, wherein the hypoallergenic flavor composition is disposed on the hypoallergenic animal food composition in an amount of about 0.5 wt % to about to about 3 wt %, based on the total weight of the hypoallergenic animal food composition.

5. The method of claim 1, wherein the hypoallergenic flavor composition further comprises an oil or fat-based reaction flavor,
wherein the oil or fat-based flavor is produced by reacting a first precursor composition comprising a vegetable oil, an animal fat, or a combination comprising one or more of the foregoing fats and oils; a reducing sugar; and a sulfur source.

6. The method of claim 5, wherein the hypoallergenic flavor composition comprises about 5 wt % to about 15 wt % of the oil or fat-based reaction flavor, about 5 wt % to about 15 wt % of the water-based reaction flavor, and about 15 wt % to about 35 wt % of a filler.

7. The method of claim 1, wherein managing comprises reducing the incidence of allergic reaction in the animal.

8. A hypoallergenic flavor composition suitable for human or animal consumption, comprising:
an oil or fat-based reaction flavor and a water-based reaction flavor,
wherein the oil or fat-based reaction flavor is produced by reacting a first precursor composition comprising a vegetable oil, an animal fat, or a combination comprising one or more of the foregoing fats and oils; a reducing sugar; and a sulfur source; and
wherein the water-based reaction flavor is produced by reacting a second precursor composition comprising water, a reducing sugar, a sulfur source, and a furanone.

9. The hypoallergenic flavor composition of claim 8, comprising about 5 wt % to about 15 wt % of the oil or fat-based reaction flavor, about 5 wt % to about 15 wt % of the water-based reaction flavor, and about 15 wt % to about 35 wt % of a filler.

10. The hypoallergenic flavor composition of claim 8, wherein the first precursor composition further comprises a nitrogen source, a spice, a hypoallergenic animal digest, a furanone, an antioxidant, or a combination comprising one or more of the foregoing components.

11. The hypoallergenic flavor composition of claim 10, wherein the first precursor composition comprises about 30 wt % to about 95 wt % of the vegetable oil or animal fat, about 3 wt % to about 20 wt % of the sulfur source, about 3 wt % to about 20 wt % of the reducing sugar, about 5 wt % to about 30 wt % of the nitrogen source, about 0 wt % to about 20 wt % of the hypoallergenic animal digest, about 0.01 wt % to about 3 wt % of the spice, about 0.1 wt % to about 5 wt % of the furanone, and about 0.01 wt % to about 0.05 wt % of the antioxidant.

12. The hypoallergenic flavor composition of claim 8, wherein the second flavor precursor composition further comprises a nitrogen source, a spice, a hypoallergenic animal digest, an antioxidant, or a combination comprising one or more of the foregoing components.

13. The hypoallergenic flavor composition of claim 12, wherein the second precursor composition comprises about 5 wt % to about 20 wt % of the sulfur source, about 3 wt % to about 15 wt % of the reducing sugar, about 0.3 wt % to about 2 wt % of the furanone, about 0 wt % to about 10 wt % of the hypoallergenic animal digest, about 0.4 wt % to about 0.6 wt % of the spice, about 8 wt % to about 15 wt % of the nitrogen source, and about 0.015 wt % to about 0.03 wt % of the antioxidant.

14. The hypoallergenic flavor composition of claim 13, wherein the flavor enhancer of the second precursor composition comprises 4-hydroxy-2,5-dimethyl-3(2H)-furanone.

15. A flavor composition for an animal food comprising
a hypoallergenic animal digest, wherein substantially all of the components of the hypoallergenic animal digest have a molecular weight of less than 4,000 daltons; and
an oil or fat-based reaction flavor, a water-based reaction flavor, or a combination comprising one or more of the foregoing reaction flavors.

16. The flavor composition of claim 15, wherein the oil or fat-based reaction flavor is produced by reacting a first precursor composition comprising a vegetable oil, an animal fat, or a combination comprising one or more of the foregoing fats and oils; a reducing sugar, and a sulfur source compound.

17. The flavor composition of claim 15, wherein the water-based reaction flavor is produced by reacting a second precursor composition comprising water, a reducing sugar, a sulfur-containing compound, and a furanone.
